(19) United States
(12) Patent Application Publication
(10) Pub. No.: US 2006/0045246 A1
(43) Pub. Date: Mar. 2, 2006

(54) Billing and payment method for networks incorporating long latency in their systems architectures

(75) Inventors: Eugene E. Pettinelli, Sudbury, MA (US); Christopher F. Wolf, Lexington, MA (US); Daniel Alexander, West Roxbury, MA (US); Amir A. Hasson, Cambridge, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: United Villages, Inc., Cambridge, MA (US)

(21) Appl. No.: 11/217,153

(22) Filed: Aug. 31, 2005

Related U.S. Application Data
(60) Provisional application No. 60/605,947, filed on Aug. 31, 2004.

(51) Int. Cl. H04M 15/00

(52) U.S. Cl. 379/114.01

(57) ABSTRACT

A billing and payment method and system for networks incorporating long latency in their systems architectures is provided. As a result of this method and system, it is possible for customers and users to experience virtual real-time access to a network incorporating long latency in its systems architecture and for the network operator to incorporate operating procedures and controls and customer payment procedures and financial controls customarily available in real-time environments. In particular, the present invention is advantageous where reconciliation of accounts and verification of account balances cannot be done in short amounts of time due to high latency of the transmissions. Also, pre-paid and/or post-paid debit and/or credit cards can be used for purchases of goods and services in an environment whereby real-time verification of balances would not otherwise be possible. Examples of networks incorporating long latency in their systems architectures are those which rely on store-and-forward methods to physically deliver voicemail, email, internet access and other data.

### BACKGROUND OF THE INVENTION

Definitions

The following definitions are intended to apply to the terms set forth.

Store-and-Forward System

An electronic data transport system where data is accumulated on a client computer(s) and/or on a computer powered device(s) for subsequent batch transmission to one or more additional computers at least one of which is connected to a real time network.

Client Computer

A computer configured with appropriate hardware and software to enable it to function as the front end or user interface in a store-and-forward system. A client computer could be associated with or incorporate equipment such as a keyboard, a monitor, a central processing unit and/or a communications device such as a headset or handset with a wired or wireless connection, and/or a card or RFID reader/writer, but not all of this equipment is necessary in each embodiment, and other equipment may provide appropriate functionality in lieu of this equipment. In some embodiments, the client computer can be an embedded processing device as may be found in cell phones, Personal Digital Assistants, laptop computers, and communications base stations.

Computer Powered Device

A personal digital assistant with telephony capabilities and configured with appropriate hardware and software to enable it to function as the front end or user interface in a store-and-forward system. A computer powered device could be associated with or incorporate equipment such as a keyboard, a screen, a central processing unit and/or a communications device such as a headset or handset with a wired or wireless connection, and/or a card or RFID reader/writer, but not all of this equipment is necessary in each embodiment, and other equipment may provide appropriate functionality in lieu of this equipment.

Access Device

A Client Computer or Computer Powered Device.

Hub Server

A computer device with direct, real-time connection to the Internet and/or other national and/or international communications infrastructure.

Physically Movable Device

A portable computer powered device.

Kiosk

The facilities at a physical location where a client computer may be available for customer access or the physical locations where a physically movable device may be made available for customer access. A client computer kiosk may be sited to enable effective transmission to and from a Mobile Access Point. Physically movable devices may have to be periodically moved to appropriate sites to enable effective transmission to and from a Mobile Access Point. In lieu of, or in addition to interacting at a fixed kiosk, in some embodiments the customer may interface with the client computer using a telephone, such as a cell phone, PDA, WiFi phone, or cordless phone.

Kiosk Agent

A local representative or machine responsible for customer services including making the kiosk services available to customers, cash collections, marketing and/or other business activities. It is to be understood that the kiosk agent may in whole or part be embodied in software resident on a client computer and/or computer powered device.

Mobile Access Point

A movable transceiver which may periodically receive and/or transmit digitized information to and from kiosks and periodically receive and/or transmit digitized information to and from a server acting as the gateway to the internet and/or telephony network(s). In some embodiments, transportation vehicles such as cars, trucks and busses may be equipped with movable local and/or wide area digital communications capabilities which can serve as mobile access points. Billing and payment systems in some embodiments can use transponders used to bill for utilization of roadways or for billing for products and services.

Customer Interface

A software program that may be resident on a client computer and/or on a physically movable device which may control the interaction between a customer and a store-and-forward system. Such controls may include, among other things, the specific actions and their sequence necessary to access the system, make inquires, provide services, display results, measure and record service sessions, maintain records including payments and credits, provide links to the revenue cycle accounting system and/or otherwise manage the process.

Revenue Cycle Accounting System

A software program that may be resident on a client computer and/or on a physically movable device and/or in one or more central locations which may maintain the activity in customers accounts at the individual customer level and at one or more levels of aggregation. The revenue cycle accounting system may contain current rate information and may interact with the Customer Interface to obtain information to compute the cost of services actually provided, receipts of payments and credit and debit terms among other typical accounting functions. It may record cash receipts and billing information.

Telephone

A device that enables users to speak and listen to audio such as a fixed telephone, cordless phone, cellular phone, WiFi phone, or walkie talkie.

The present invention relates to billing and payment methods for networks incorporating long latency in their systems architectures, for example store-and-forward systems for voicemail, email, internet access and other data services, and the use of pre-paid and/or post-paid debit and/or credit cards used for the purchase of goods and services.

Approximately four billion people live in rural areas of the world with undeveloped communications infrastructures. One development that may increase the quality of life for these people and improve their economic prospects may be the bringing of very low cost communications and the ability to purchase goods and services via debit and credit instruments such as debit and credit cards to their towns and villages. Because current telecommunications infrastructure for services such as cell phones and internet related data is expensive, and because typical incomes of these people are low, it has not always been cost effective to provide such services. One method that may hold promise to reduce the capital expenses and operating costs of delivering telecommunications services is the use of store-and-forward technologies such as have been developed and deployed by DakNet, or by the use of wide area 802.11 or 802.11 (X) wireless services in combination with or as a replacement for DakNet mobile technologies.

In systems like the DakNet system, voice, email, payment and other accounting information and other digitized information may be collected at a village computer kiosk and picked up by a movable transceiver which goes by the village on a periodic basis such as daily or weekly. At the same time, voice, email and other accounting information and other digitized information held by the transceiver may be electronically dropped off at the kiosk for later retrieval by the recipient. Such voice, email and credit/debit digitized information may have been previously obtained by the transceiver from location(s) that has/have access to the internet and/or access to other telecommunications infrastructures. This type of system can have very high latency of communications. In remote areas, for example, users may be limited to the receipt and transmittal of voice and email messages, or debit or credit balance information once a day, or less frequently, depending on when the physical transport of the transceiver picking up and/or dropping off information passes by their village computer kiosk.

An inherent limitation of a store-and-forward system can be the lack of the real time billing capabilities common in existing telephony and data networks. This limitation may be exacerbated in environments where it is impractical to invoice subsequently for services provided and a means of prepayment or payment such as phone cards and pre-paid debit cards may become desirable. However, the inability to access the network in real time to determine the amount of a user's prepaid balance, if any, prior to providing the goods or services and other factors may make existing prepayment or payment systems impractical without further adding to latency and/or significantly degrading the user's experience. Alternative existing means of determining the amount of a user's prepaid balance, if any, prior to providing the goods or services such as read/write magnetic cards, RFID cards or other editable cards or paper may not be available or may not be suitable due to environmental conditions, supply logistics, or maintenance requirements or they may not be cost effective in comparison with the methods set forth hereinbelow, although they may be incorporated into those methods.

It would be desirable, therefore, to provide a method that allows and facilitates billing and payment for networks incorporating long latency in their systems architectures such as store-and-forward systems. In particular it would be desirable to provide a method that allows billing and payment for voicemail, email, and other goods and services including debit/credit digitized information and other telecommunications modalities which is virtually real time from the user's perspective while providing management controls and accounting controls similar in efficacy to those provided by real time network billing systems. The store-and-forward system is anticipated to serve comparatively remote areas and the methods disclosed herein, as software programs, may be maintained and modified across all locations within the network remotely.

Because the nature of communications such as email, voice mail, and web-based internet pages may be different from accounting data, in some circumstances it may be useful to separate this information in a two-tiered fashion and have it travel separate pathways to its destination. For example, it may be more cost-efficient to store the accounting information at each node on the network but not store voice mail at each node, in which case the voice and accounting information would travel separate paths to their destinations.

### SUMMARY OF THE INVENTION

A billing method and system for networks incorporating long latency in their systems architectures, for example store-and-forward voicemail, email, internet, debit and credit cards, pre-paid phone cards and other data and financial services.

The method and system in some embodiments may comprise recording, collecting and maintaining electronic billing information, debiting or crediting the customer's account, displaying remaining debit or credit information back to the operator or customer, temporarily storing and, subsequently, delivering such information, including management, operations and control information, from a computer kiosk or from a physically movable device to a distributed or centralized accounting system. The distributed or centralized accounting system may reperform the activities completed by the kiosk or physically movable device, compare results, generate adjustments, if necessary, for delivery back to the kiosk or physically movable device, maintain the system of record and forward accounting, management, operations and control information to the next level in the organization structure.

A method for payment for usage of a long latency network by a customer may comprise in some embodiments establishing an account for the customer; accepting payment from the customer; if the customer payment balance in an access device is sufficient, permitting the initiation of the requested service usage by the customer; monitoring in the access device the quantity of service usage by the customer; reducing the customer balance in the access device by the price charged for the service; after the termination of the service usage, transmitting customer account and service usage information from the access device to a mobile access point; transmitting the said customer account and service usage information from the mobile access point to a hub; verifying the customer service usage and the cost thereof at the hub; and transmitting customer account adjustments from the hub to the access device by means of a mobile access point.

The customer payment balance in some embodiments may be stored in the access device, the mobile access point, a nearest Hub server, and/or in Hub servers other than the nearest Hub server.

The customer service usage in some embodiments may comprise accessing on the access device voice-mail or electronic mail previously received at the access device by means of the mobile access point, accessing on the access device material from the Internet previously received at the access device by means of the mobile access point, preparing voice-mail or electronic mail at the access device for subsequent transmission from the access device by means of the mobile access point, and/or preparing requests for material from the Internet at the access device for subsequent transmission from the access device by means of the mobile access point.

The customer service usage in some embodiments may be terminated when the accumulated cost thereof exceeds the customer payment balance in the access device. The customer may use a telephone to interface with the access device. The mobile access point may be made part of a transportation vehicle.

A system for payment for usage of a long latency network in some embodiments may comprise: an access device with a customer interface; a revenue cycle accounting system resident thereon; a mobile access point capable of communicating with the access device; and a Hub server capable of communicating with the mobile access point and with external communications networks.

The external communications networks may be packet-switched networks, such as the Internet. The customer interface may be a telephone. The mobile access point may be a transportation vehicle.

### BRIEF DESCRIPTION OF THE DRAWINGS

FIG. 1 illustrates elements which may be involved in the billing and payment method and system according to some embodiments of the present invention. It is to be understood that this illustration is exemplary only, and that the same principles will apply in other embodiments.

FIG. 2 further illustrates elements which may be involved in the billing and payment method and system according to some embodiments of the present invention. It is to be understood that this illustration is exemplary only, and that the same principles will apply in other embodiments.

### DETAILED DESCRIPTION OF AN EMBODIMENT

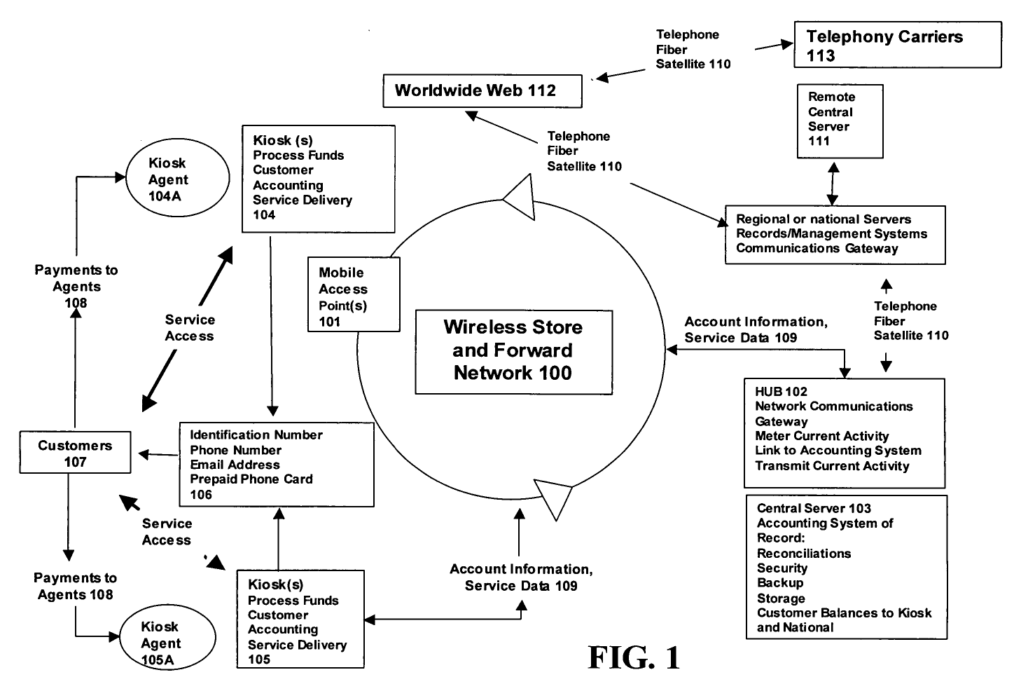

Referring to FIG. 1, at each kiosk, 104 and 105 for example, there may exist one or more client computers 120 and/or computer powered devices 121 such as personal digital assistants (PDAs) with a phone-type device such as a headset, digital phone, handset, etc. with wireless capability, and/or a card or RFID reader/writer, which as described herein may connect to the store-and-forward network 100. The computer powered device 121 may be portable. (For simplicity, only kiosk 104 in FIG. 1 is shown with a client computer 120 and a computer powered device 121, but it will be understood that other kiosks in the system such as kiosk 105 may be similarly equipped.) The kiosks may be located at the same or at different physical locations.

At each kiosk, 104 and 105 for example, an accounting system for debiting and crediting to the customer's account may be resident on the client computer 120 or computer powered device 121. The accounting system may incorporate typical revenue cycle accounting functionality such as account set up, maintenance, administration, inquiry, billing, credit, collection, account balances, account history, aggregations, transaction summaries, various reconciliations and/or reporting.

When a new or existing Customer 107 requests voicemail, email, internet access or a combination of these or other available services, the kiosk agent, 123 and 124 for example, may perform the new account set up actions on the client computer 120 or computer powered device 121 and may provide the new or existing Customer 107 with a card bearing an unique account number which may or may not be associated with a telephone number accessing the store and forward network 100. Such number may be printed on a paper or plastic card or it may be printed on or embedded in a preprinted or electronic card 106 or on any other tangible medium. In addition, the accounting system may assign to the Customer 107 a voice mailbox number, which may or may not be different from the Customer's account number, and/or an email address.

When a Customer 107 wants to send voicemail, email, obtain internet access or obtain other available services, the kiosk agent, 123 and 124 for example, may use the client computer 120 or computer powered device 121 to obtain information with respect to the rate for each unit of the requested service from the revenue cycle accounting system and then communicate the rate to the Customer 107, or the kiosk agent may direct the Customer 107 to a rate card, or the Customer 107 may self-serve and use the client computer 120 or computer powered device 121 to obtain the rate information.

The Customer 107 may designate the desired rate and type of service and then may make a payment 108 which may be a prepayment or payment for a number of units of service or a payment for a single unit of service. In one embodiment, the card 106 which the Customer 107 may receive may be or may encompass a prepaid phone card 106 in a fixed or variable currency denomination or in a fixed or variable unit of service denomination and the corresponding information may be added in electronic form to the kiosk client computer 120 or computer powered device 121. In another embodiment, the Customer's prepayment or payment or account data may be maintained solely in electronic form on the kiosk client computer 120 or computer powered device 121.

The Customer 107 may pay 108 the kiosk agent, 123 or 124 for example, who, in turn, may enter the Customer's account number and then the type of payment, the amount, telephone number, email address or worldwide web address and other relevant data into the Customer's account maintained on the revenue cycle accounting system.

The kiosk agent, 123 or 124 for example, may open the Customer Interface program resident on the kiosk client computer 120 or computer powered device 121 and may enter a specific service to be provided in a specific or variable number of service units for the Customer 107. The Customer Interface program may interact with the revenue cycle accounting system to determine whether the Customer's prepaid balance is sufficient to enable the requested service and service units. If so, the kiosk agent, 123 or 124 for example, may activate the phone-type device in one embodiment via the Customer Interface, or in another embodiment may permit access, via the Customer Interface enabled browser, to content previously received by the client computer 120 or computer powered device 121 from the worldwide web 112 through the Mobile Access Point 101, in either case enabling the Customer 107 to obtain the previously specified service units. In another embodiment the Customer 107 may self-serve this process. In another embodiment the Customer's prepaid balance may be insufficient to enable the requested service and service units and the kiosk agent may agree to invoice the Customer 107 or to other arrangements for subsequent payment.

The kiosk agent, 123 or 124 for example, may then initiate a usage session for the Customer 107 during which the kiosk agent may fully or partially operate the phone-type device or the Customer Interface enabled browser in conjunction with or on behalf of the Customer 107 or the kiosk agent may hand over the entire process to the Customer 107.

During the Customer usage session, the Customer Interface program resident on the kiosk client computer 120 or computer powered device 121 may meter the service units provided to the Customer 107. In one embodiment, the Customer Interface program may generate a graphic display on the kiosk client computer 120 or computer powered device 121 to indicate to the kiosk agent, 123 or 124 for example, and to the Customer 107 the relative proportions of the service unit(s) which have elapsed and the amount remaining. The graphic display may be in the form of a numerical countdown. In other embodiments, the Customer Interface program may provide audio signals in addition to the graphic display or provide audio signals in lieu of a graphic display. The Customer Interface program may measure and record the duration of the session and/or the amount of data transferred and may provide a warning as the session is about to conclude. Upon expiration of the service unit(s) the Customer Interface program may end the usage session and disconnect the Customer 107.

Upon conclusion of the usage session the Customer Interface program resident on the kiosk client computer 120 or computer powered device 121 may access the revenue cycle accounting system and may pass appropriate information with respect to the services provided in order for the revenue cycle accounting system to compute the cost and then decrement the Customer's account for the cost of the service provided. In one embodiment, the kiosk agent, 123 or 124 for example, may communicate the remaining balance, if any, in the Customer's account to the Customer 107. In other embodiments, the remaining balance, if any, in the Customer's account may be graphically displayed to the Customer 107 and/or communicated by audio signal.

The revenue cycle accounting system and the Customer Interface program resident on the kiosk client computer 120 or computer powered device 121 may maintain records of Customer activity by account, in total and/or in sub-groupings, by date and/or cumulatively.

Periodically, daily in one embodiment, the proximity of a Mobile Access Point 101 will permit a radio link between the kiosk client computer 120 or computer powered device 121 and a Mobile Access Point 101. (It will be understood that there may be a plurality of Mobile Access Points associated with the system, which may service the same or differing kiosks at various times.) Once a link is established, the kiosk client computer 120 or computer powered device 121 may transmit account information and service data 109, for example: 1.) the activity since the previous transmission and/or the account balances maintained on the revenue cycle accounting system and/or the total cash collected by the kiosk agent since the previous transmission; 2.) the metered activity since the previous transmission and/or the account balances maintained on the Customer Interface program and/or 3.) the voicemail, email, internet access and/or other activity by some or all of the kiosk's customers since the previous transmission. The Mobile Access Point may transmit for later display to a kiosk customer material requested from the internet, and/or voicemail or email transmissions intended for one or more customers. The Mobile Access Point 101 may store some or all of the data from transmissions it receives.

The Mobile Access Point 101 may continue on its pre-established route obtaining and storing transmissions from a plurality of kiosk client computers, 120 for example, or computer powered devices, 121 for example. In addition, the Mobile Access Point 101 may make transmissions to kiosk client computers, 120 for example, or computer powered devices, 121 for example, as further described herein until it reaches its terminal at a network Hub 102. The Hub 102 and central server 103 may or may not be co-located.

Upon reaching proximity to the network Hub 102 or central server 103, the Mobile Access Point 101 may transmit account information and service data 109 it has obtained from the kiosk client computers, 120 for example, or computer powered devices, 121 for example, to the Hub 102 and central server 103. In one embodiment, the revenue cycle accounting system information and the Customer Interface information received by the central server 103 may be processed at the Hub and, in another embodiment, such information may be transmitted over telephone, cellular, fiber or satellite connection(s) 110 to a remote central server or servers 111 for processing.

The voicemail and/or email and/or internet access activity and/or data associated with any other services provided to the Hub's customers as collected by the Mobile Access Points, 101 for example, and stored on the central server 103 may be independently metered at the Hub 102, as it is transmitted over existing telephone, cellular, fiber or satellite connections 110 for accessing the worldwide web 112 and/or ultimate delivery to third parties via telephony carriers 113. The Hub may verify by customer account the service units provided, the duration of each customer session and/or the amount of data transferred. Software at the central server 103 may compare metered results at the central server 103 with the Customer Interface data collected from the kiosk client computers, 120 for example, or computer powered devices, 121 for example, and may identify discrepancies, if any, for subsequent disposition. Minor discrepancies may result in adjustments to customer accounts or may be ignored. Adjustments may be developed at the customer account level.

The central server 103 in one embodiment or a remote central server 111 or servers in another embodiment may maintain the system of record for the revenue cycle accounting system and/or Customer Interface program. The systems of records may contain, for example, reconciliation capabilities, backup capabilities, storage capabilities, security capabilities and/or scalability capabilities which either are enhanced versions of certain elements of the corresponding revenue cycle accounting system and the Customer Interface program resident on the kiosk client computers, 120 for example, or computer powered devices, 121 for example, or may include capabilities which do not exist on the kiosk client computers, 120 for example or computer powered devices, 121 for example. The system of record for the revenue cycle accounting system and/or the Customer Interface may process the latest activity collected at the central server 103, may add such activity to the prior balances at the Customer level, intermediate levels and in the aggregate and/or may compare the current balances thus obtained with the corresponding balances obtained from the kiosk client computers, 120 for example, or computer powered devices, 121 for example, respective revenue cycle accounting system and/or Customer Interface program.

The central server 103 in one embodiment may transmit 110 the ending account balances for each Customer 107 to a remote server or servers. In another embodiment a remote server or servers may maintain the ending account balances for each Customer 107 and may be accessible to all other hubs. Both embodiments may enable customers with prepaid balances to access the store and forward network 100 and/or their respective accounts from any kiosk client computer, 120 for example, or computer powered device, 121 for example, located on any Hub 102.

The revenue cycle accounting system and the Customer Interface program together provide processing, accounting and/or control over revenue recorded and/or the services actually provided. The present method of duplicate processing which occurs at the kiosk client computer 120 or computer powered device 121 and at the central server 103 or at remote central server 111 levels may enable virtual real-time processing, and robust management accounting and financial control similar to that provided by accounting systems employed by telephony networks. However, the present method may permit these activities to occur offline and without a time lag apparent to Customers as would normally be expected in a long latency environment. In addition, the duplicate processing demonstrates to the kiosk agent, 123 or 124 for example, that there is timely and complete management oversight over kiosk activity. Among other features, the duplicate processing may provide a clear computation of amounts due from the kiosk agent, 123 or 124 for example, to facilitate settlements; may ensure mechanical accuracy and completeness of processing; may ensure correct pricing; may create adjusting entries, if necessary, for transmission back to kiosk client computers, 120 for example or computer powered device 121 to reflect charges for services actually processed by the Hub; may create the transaction registers supporting general ledger entries at the parent company and at appropriate intermediate accounting levels; may provide the parent company, and/or its partner(s) and/or licensor(s) and/or licensee(s) with a means of verifying activity occurring at all network operating levels; may enable a real time telecommunications link at the Hub(s) to collect, analyze, interrogate, review, summarize and report financial and operating information; and, finally, may provide a means of restoring all Customer information to kiosk client computers, 120 for example, or computer powered devices, 121 for example, in the event of lost or damaged data or hardware at the kiosk client computers, 120 for example, or computer powered devices, 121 for example.

The Mobile Access Point 101, upon reaching proximity to the Hub 102 and prior to commencing its next pre-established route 100, may obtain and store a transmission 109 from the central server 103 consisting of adjustments, if any, to the prior customer account balances for each kiosk client computer 120 or computer powered device 121 on the route 100 from the system of record for the revenue cycle accounting system and/or the Customer Interface. In one embodiment, this may occur at the end of the route and immediately following the transmissions by the Mobile Access Point 101 to the central server 103 and in another embodiment this may occur at a later time and prior to the beginning of the next route.

Periodically, daily in one embodiment, the Mobile Access Point 101 may commence a new trip around its route to begin the process.

The Mobile Access Point 101, upon reaching proximity to each respective kiosk client computer 120 or computer powered device 121 on its route may transmit adjustments, if any, to the prior balances to each respective kiosk client computer 120 or computer powered device 121 on the route 100 which the Mobile Access Point 101 had obtained from the system of record for the revenue cycle accounting system and/or the Customer Interface.

Kiosk client computers, 120 for example, and/or computer powered devices, 121 for example, on the Mobile Access Point's 101 route may receive adjustments, if any, to its prior balances by customer which the Mobil Access Point 101 had obtained from the system of record for the revenue cycle accounting system and/or the Customer Interface. The revenue cycle accounting system and/or the Customer Interface electronically may record such adjustments to update its prior balances prior to processing current activity and for reporting to Customers 107 in connection with their next activity at the kiosk.

Regardless of whether it is maintained at the central server at the Hub(s) or at a remote server or servers, the system of record periodically may transmit financial and operational information to the parent company and/or to appropriate intermediate level entities for purposes such as recording, financial analyses, control, operations, operations analyses, planning, remittances, tax reporting, licensing and/or reporting, for example.

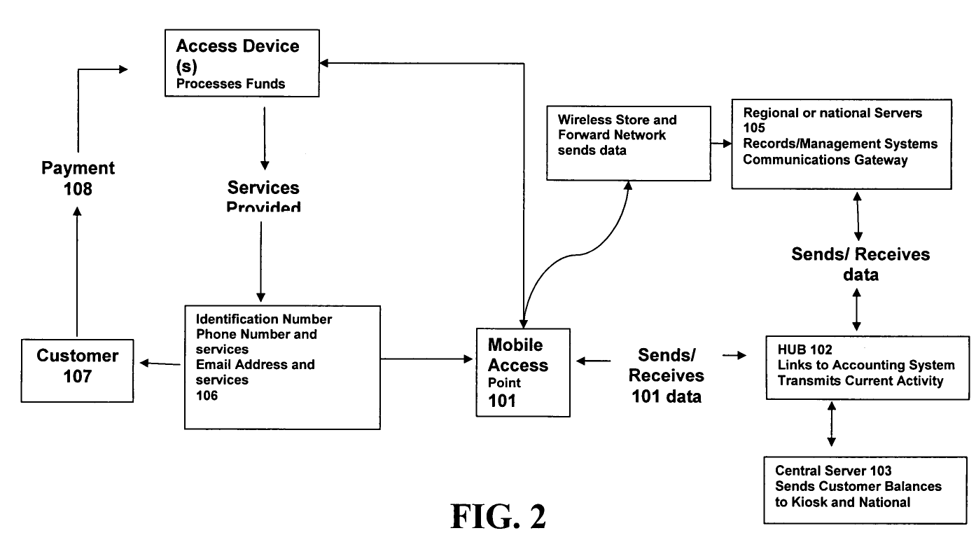

FIG. 2 illustrates a simplified flow diagram of an embodiment. The customer 107 initiates the process by paying 108 the agent at the kiosk a certain amount of funds for pre-paid services. The agent processes the funds 104 using the kiosk which may provide such information to the agent and customer as an identification and phone number, and email address 108, 106. The agent may issue a phone card 108, 106 to the customer on which the prepaid amount is either encoded or which has a numerical link to the customer's prepaid status and balance amount. This information is also stored for transmission to the mobile access point 101 which confirms the data with the kiosk and sends 101 this data to the hub 102 when it is within communications range. The hub 102 links and sends this information with the central server 103 and regional or national servers 105 which act as gateways. This information is then sent to the wireless store and forward network via the means shown in FIG. 1 to and from the mobile access points 101.

The billing and payment method described herein provides virtual real-time access to networks incorporating long latency in their systems architectures. In the method, the payment, usage and/or billing information may be delivered to and received from a distributed or centralized accounting system via a store-and-forward network, which may but need not incorporate Wi-Fi technology, and may but need not incorporate Wi-Fi technology links between stationary and physically movable devices. The accounting information may be separated from the voice, data and/or internet message data and may travel on separate paths to the destination.

It will be understood that although the embodiments described herein utilize client computers and/or computer powered devices at kiosks, other devices with appropriate capabilities may be utilized in their place, without departing from the spirit and scope of the methods described herein. By the same token, it will be understood that although the embodiments described herein are associated with the provision of voicemail, email and/or internet services, other services may be provided, either in addition to or in place of those services, without departing from the spirit and scope of the methods described herein.

It will be recognized that the descriptions given here have been with reference to specific embodiments of the method. These descriptions have been for illustrative purposes only, however, and it will be understood by a person of skill in the art that the techniques set forth herein are of more general applicability to other embodiments as well. Moreover, while the invention has been disclosed in connection with the preferred embodiments shown and described in detail, various modifications and improvements thereon will become readily apparent to those skilled in the art.

What is claimed is:

1. A method for payment for usage of a long latency network by a customer, comprising:
a. establishing an account for the customer;
b. accepting payment from the customer;
c. if the customer payment balance in an access device is sufficient, permitting the initiation of the requested service usage by the customer;
d. monitoring in the access device the quantity of service usage by the customer;
e. reducing the customer balance in the access device by the price charged for the service;
f. after the termination of the service usage, transmitting customer account and service usage information from the access device to a mobile access point;
g. transmitting the said customer account and service usage information from the mobile access point to a hub;
h. verifying the customer service usage and the cost thereof at the hub; and
i. transmitting customer account adjustments from the hub to the access device by means of a mobile access point.

2. The method of claim 1, wherein the customer payment balance is stored in the access device and the mobile access point.

3. The method of claim 2, wherein the customer payment balance is stored in a nearest Hub server.

4. The method of claim 1, wherein the customer payment balance is stored in the access device and a nearest Hub server.

5. The method of claim 1, wherein the customer payment balance is stored in only a nearest Hub server.

6. The method of claim 1, wherein the customer payment balance is stored in Hub servers other than a Hub server nearest to the customer.

7. The method of claim 2, wherein the customer payment balance is stored in Hub servers other than a Hub server nearest to the customer.

8. The method of claim 3, wherein the customer payment balance is stored in Hub servers other than the Hub server nearest to the customer.

9. The method of claim 4, wherein the customer payment balance is stored in Hub servers other than the Hub server nearest to the customer.

10. The method of claim 1, wherein the customer service usage comprises accessing on the access device voice-mail or electronic mail previously received at the access device by means of the mobile access point.

11. The method of claim 1, wherein the customer service usage comprises accessing on the access device material from the Internet previously received at the access device by means of the mobile access point.

12. The method of claim 1, wherein the customer service usage comprises preparing voice-mail or electronic mail at the access device for subsequent transmission from the access device by means of the mobile access point.

13. The method of claim 1, wherein the customer service usage comprises preparing requests for material from the Internet at the access device for subsequent transmission from the access device by means of the mobile access point.

14. The method of claim 1, wherein the customer service usage is terminated when the accumulated cost thereof exceeds the customer payment balance in the access device.

15. A system for payment for usage of a long latency network, comprising:
a. an access device with a customer interface;
b. a revenue cycle accounting system resident thereon;
c. a mobile access point capable of communicating with the access device; and
d. a Hub server capable of communicating with the mobile access point and with external communications networks;

16. The system of claim 15, wherein the external communications networks are packet-switched networks.

17. The system of claim 16, where the packet-switched networks are the Internet.

18. The method of claim 1, wherein the customer uses a telephone to interface with the access device.

19. The system of claim 15, wherein the customer interface is a telephone.

20. The method of claim 1, wherein the mobile access point is made part of a transportation vehicle.

21. The system of claim 15, wherein the mobile access point is a transportation vehicle.
